(19) United States
(12) Patent Application Publication
(10) Pub. No.: US 2022/0107817 A1
(43) Pub. Date: Apr. 7, 2022

(54) Dynamic System Parameter for Robotics Automation

(71) Applicant: Bank of America Corporation, Charlotte, NC (US)

(72) Inventors: Sakshi Bakshi, New Delhi (IN); Siva Kumar Paini, Hyderabad (IN)

(21) Appl. No.: 17/060,136

(22) Filed: Oct. 1, 2020

(51) Int. Cl. G06F 9/445; G06N 20/00; G06F 11/34

(52) U.S. Cl. CPC G06F 9/44505; G06F 11/3457; G06F 11/3438; G06N 20/00

(57) ABSTRACT

Configuration parameter values associated with executing an application on a computing system may be determined by computational optimization based on configuration parameter values and/or monitored performance metrics associated with executing the application on the computing system. Configuration parameter values associated with executing the application on the computing system may be updated based on monitored performance metrics associated with executing the application.

### FIELD

Aspects described herein generally relate to computer systems and networks. More specifically, aspects of this disclosure relate to dynamic system parameter for robotics automation.

### BACKGROUND

Client-server computing systems and enterprise software applications are typically designed to operate according to various adjustable configuration settings. The configuration settings typically control operational aspects such as maximum number of permitted simultaneous users, maximum permissible file size acceptable as input, or values of the outer limits of permissible ranges for various variables or parameters. Robotics automation systems typically use parameters such as wait event conditions to facilitate timing flexibility between the start of a first process and the start of a second process.

### SUMMARY

Aspects of the disclosure may provide solutions that address and overcome technical problems associated with robotics automation systems. One or more aspects of the disclosure may relate to determining one or more preferred configuration settings for an application executing in a computing system environment.

Enterprise software applications developed and/or deployed in a first computing system environment, for example, a private client-server system including one or more computing servers, may be deployed after development on and/or migrated to a second computing system environment, for example, a cloud computing system or third-party hosted client-server system. The migrating may be performed by recompiling source code designed for the first computing system environment to be deployed in the second computing system environment. The recompiling may be performed using a code compiler, object code library, and related tools and/or associated files associated with generating executable code for the second computing system environment. For interpreted computer languages and/or scripts, the compiling may be replaced with source code editing. When migrating, differences in the second computing system environment compared to the first computing system environment may be accounted for by making changes in the source code designed for the first computing system environment to conform to requirements of the second computing system environment before being recompiled and/or edited to be migrated and deployed in the second computing system environment.

Traditionally, configuration settings may be left in a default state when deploying the application in a different computing system environment than that on which the application was developed, or migrating the application. In accordance with one or more arrangements, as discussed herein, configuration settings and parameters may be evaluated to determine modifications and/or improvements to configuration settings for the application and/or associated host computing system environment based on the application being deployed on or migrated to the second computing system environment. The configuration settings and parameters to be evaluated may include system configuration, software configuration, network bandwidth, and application performance settings and parameters that may be varied. Variations in performance without corresponding changes to configuration parameter settings may lead to software process failures.

The configuration settings may be initially chosen according to values that have been demonstrated or are anticipated to produce desirable performance results. Various system configurations, conditions, and performance results of client-server computing systems and enterprise software applications may be measured and analyzed for modification. The modifications may be based on analysis of network bandwidth, background processes, central processing unit (CPU) utilization, server capacity, data availability, resource availability, and time delays between requesting data from a data source and receiving the data, to optimize system performance taking the computing system environment into account. The modifications may be made recursively beginning with one configuration parameter and progressing recursively through the rest of the configuration parameters. Stored success and failure data may be analyzed in combination with associated system configuration and performance data to determine modifications for system configuration parameters. Machine learning and/or artificial intelligence algorithms may be applied for analyzing data and determining configuration parameters to be applied. Logging both success and failure scenarios from each execution may facilitate improved machine learning and efficiency improvements in estimating outputs. The machine learning may be performed independently of environmental factors, system configuration, and/or system conditions.

A parameterized condition between processes may be determined via analysis of the state of the system configuration and software-related parameters. A first variable extracted may begin initiation of a recursive variable check, and information may be fed into a dynamic model to determine configuration parameter values for one or more processes. A machine learning algorithm may be applied on a data repository or database to calculate output parameters for responsive system configurations. The output parameters may be input into a robotics automation system.

An exemplary method may comprise causing execution, based on a first set of configuration parameter values, of a target application on the computing system. One or more performance metrics of the computing system may be monitored. One or more second sets of configuration parameter values may be determined, based on at least one of the first set of configuration parameter values or the monitored one or more performance metrics. The method may further include causing execution, based on the determined one or more second sets of configuration parameter values, of the target application on the computing system. The method may include determining the one or more second sets of configuration parameter values by performing computational optimization, based on at least one of the first set of configuration parameter values or the monitored one or more performance metrics, of one or more associated configuration parameters. The method may include monitoring one or more performance metrics of a plurality of layers of an OSI stack associated with execution of the target application on the computing system, and determining, based on at least one of the first set of configuration parameter values or the monitored one or more performance metrics of the plurality of layers of the OSI stack, the one or more second sets of configuration parameter values. The method may include recursively determining one or more next sets of configuration parameter values based on the one or more second sets of configuration parameter values, one or more subsequent sets of configuration parameter values, and/or one or more monitored performance metrics associated with one or more corresponding sets of configuration parameter values. The method may include performing machine learning using at least one of the first set of configuration parameter values or the monitored one or more performance metrics to determine the one or more second sets of configuration parameter values. The one or more performance metrics may include at least one of a success or an error based on a success determination factor or an error determination factor. The method may include iterating over a range of values for the first set of configuration parameter values while monitoring the one or more performance metrics. The method may include determining one or more correlations between one or more of the first set of configuration parameter values or the one or more performance metrics. Determining the one or more second sets of configuration parameter values may further be based on the one or more correlations. The target application may comprise robotics automation to simulate performance of the computing system by one or more users.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for dynamic system parameter for robotics automation, in accordance with one or more example arrangements; and

FIG. 2 depicts a system for dynamic configuration parameter settings for robotics automation, in accordance with one or more example arrangements.

FIG. 3 depicts a process flow for performing dynamic system configuration parameter settings for robotics automation, in accordance with one or more example arrangements.

FIG. 4 depicts a process flow for performing dynamic system configuration parameter settings for robotics automation, in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. It is to be understood that other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Various aspects of this disclosure relate to devices, systems, and methods for dynamic system configuration parameter setting for robotics automation. An entity (e.g., a computing device, a private computing network, an enterprise organization, a multi-platform computing network, and the like) may be associated with an executable application developed on and/or deployed for execution and access by users via a first computing system environment, for example, including one or more private computing system environments. The entity may deploy and/or migrate the executable application to a second computing system environment, for example, including one or more third-party hosted cloud servers for a client-server system. The first computing system environment and/or the second computing system environment may include one or more of a web server, an application server, a database server, an encryption device, a storage device, or a file server.

The entity may perform dynamic system configuration parameter setting for robotics automation of the executable application based on an expectation of various benefits, for example, increased processing speeds, greater throughput, ability to handle more simultaneous users or user requests, and/or straightforward scalability as the number of users increases or decreases. The scalability benefits may include meeting dynamically changing computing capabilities requirements without requiring dedicated resources to meet the maximum peak performance requirements at all times, although the maximum peak performance may only be infrequently required. Although code (e.g., computer source code written in a computer programming language such as PYTHON, JAVA SCRIPT, and the like) for the executable application may have been modified to target the second computing system environment and/or recompiled with libraries targeted toward the second computing system environment, these modifications may not capture or reflect all of the operational and/or environment differences of the second computing system environment compared to the first computing system environment.

Typically, the various application and/or computing system configuration parameter settings of the first computing system environment may simply be copied and adopted by the deployed and/or newly migrated executable application and/or second computing system environment. The configuration parameter settings may include a quantity of workload processes that may be executed simultaneously, a quantity of operations per second that may be performed by the computing system environment, a quantity of memory addresses that may be allocated to one or more processes executed by the computing system environment, or others. An ideal set of application and/or computing system configuration settings for the migrated executable application and/or second computing system environment has traditionally not been determined due to an absence of predictive information pertaining to the computational requirements, operational behavior, and performance of the migrated executable application and/or second computing system environment after the migration is completed. Configuration parameter setting values copied from the first computing system environment to the migrated executable application and/or second computing system environment may not yield acceptable performance by the migrated executable application and/or second computing system environment due to varying computational requirements, operational behavior, and/or performance of the migrated executable application and/or second computing system environment compared to the original executable application and/or first computing system environment.

The second computing system environment may have one or more performance characteristics different than corresponding characteristics of the first computing system environment. These differences in characteristics may lead to unexpected performance problems associated with the simple adoption of the configuration parameter settings for the migrated executable application based on the first computing system environment. These unexpected performance problems may appear after a period of time after initial launch of the migrated executable application on the second computing system environment, for example, one or more days, weeks, or months. Therefore, simply copying and adopting the various application and/or computing system configuration settings of the first computing system environment by the newly migrated executable application and/or second computing system environment may not yield the various benefits expected by the migration and/or may introduce unexpected problems.

For example, the migrated executable application may be unable to effectively process a certain quantity (e.g., 15, 50, or other quantity) of simultaneous users or user requests at a given time based on a default set of configuration parameter settings, whereas the original executable application executing on the first computing system environment may not have had problems processing the same certain quantity of simultaneous users or user requests at a given time based on the default set of configuration parameter settings. Performance issues arising in the migrated executable application on the second computing system environment may be due to one or more servers of the second computing system environment not being configured optimally. Configuration parameters set for the original executable application on the first computing system environment simply being copied over to the migrated executable application on the second computing system environment without a new analysis based on the actual second computing system environment and/or software deployed thereon may lead to the introduction of the performance issues and/or operational problems and errors. Performance may be dependent upon configuration parameter settings for the executable application, the computing system on which the executable application executes, the computing network over which the executable application communicates with various data users and data providers, and/or other factors of the computing system environment, such as other processes being executed on the computing system.

Arrangements discussed herein may address the aforementioned issues by dynamically determining configuration parameter values based on both computing system configurations and software conditions. Configuration parameters may be analyzed and optimized for network bandwidth, background processes, CPU utilization, server capacity, data availability, and resource availability. The analysis and optimization of configuration parameters may be based on monitoring software application and computing system performance in relation to one or more configuration parameter settings. The optimization of configuration parameter settings may include determining optimal configuration parameter values and/or ranges of preferred and/or acceptable configuration parameter values. Computational optimization, for example, multidimensional optimization, polynomial optimization, artificial intelligence, and/or machine learning techniques may be used to determine best configuration parameter setting values and/or value ranges based on designated target performance metrics based on the monitored application and/or network performance associated with the host computing system environment.

Ongoing adjustments to configuration parameter values may be determined based on ongoing monitoring of performance metrics of deployed robotics automation systems in the host computing system environment. The ongoing adjustments to configuration parameter values may comprise determining optimal configuration parameter values and/or ranges of preferred and/or acceptable application and/or computing system configuration parameter values. The ongoing adjustments to configuration parameter values may comprise determining interdependencies of the various configuration parameters and values. Multidimensional optimization, polynomial optimization, artificial intelligence, and/or machine learning techniques may be used to determine best configuration parameter values and/or value ranges based on designated target performance metrics, based on interdependencies of the configuration parameters and values, and/or based on the monitored performance of an application and/or the computing system environment.

Ongoing monitoring and evaluation of the application and/or the computing system environment hosting the application may comprise monitoring, logging, and/or analyzing real-time/runtime configuration parameter values and/or real-time/runtime performance metrics. The configuration parameter values and/or performance metrics may be those of a computing system, executable application, data layer communications, operating system (OS) layer communications, network layer communications, bare metal communications, storage communications, virtualization processes, and/or one or more of a plurality of layers of an Open Systems Interconnection (OSI) model and/or OSI protocol stack associated with any one or more of the above. Logged real-time/runtime data may be validated against defined policies and/or templates. Deviations from acceptable values and ranges may be flagged to notify an administrative function of the deviations, initiate an analysis, and/or initiate a determination of one or more corrective actions that may be taken to bring the performance metrics back into conformance with the policies and/or templates.

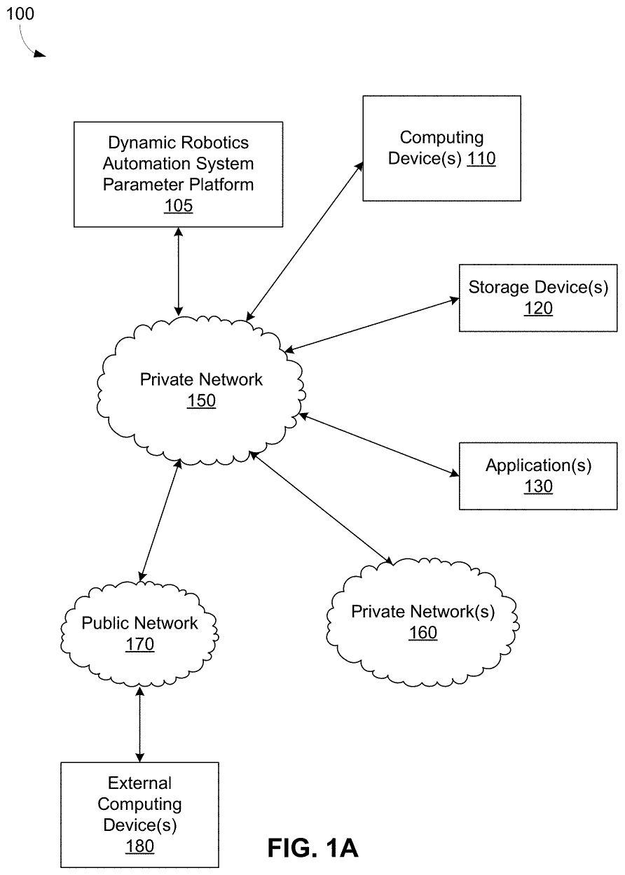

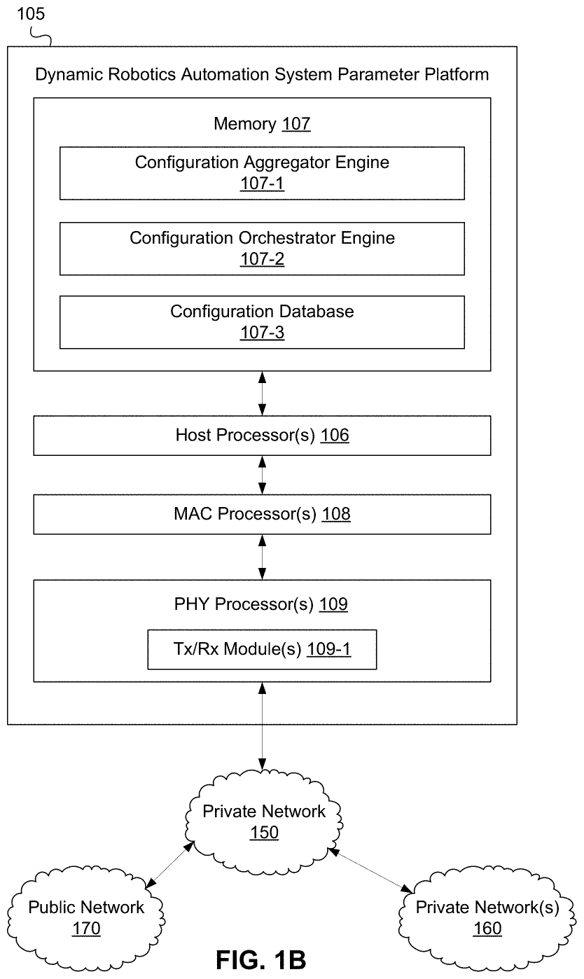

FIGS. 1A and 1B depict an illustrative computing environment for implementing aspects described herein, in accordance with one or more example arrangements. Referring to FIG. 1A, a computing environment 100 may comprise one or more devices (e.g., computer systems, communication devices, servers). The computing environment 100 may comprise, for example, a dynamic robotics automation system parameter platform 105, one or more computing device(s) 110, and one or more storage device(s) 120 linked over a private network 150. The storage device(s) 120 may comprise a database, for example, a relational database (e.g., Relational Database Management System (RDBMS), Structured Query Language (SQL), and the like). One or more application(s) 130 may operate on one or more computing devices or servers associated with the private network 150. The private network 150 may comprise an enterprise private network, for example.

The computing environment 100 may comprise one or more networks (e.g., public networks and/or private networks), which may interconnect one or more of the dynamic robotics automation system parameter platform 105, the computing device(s) 110, the storage device(s) 120, and/or one or more other devices and computing servers. One or more applications 130 may operate on one or more devices in the computing environment 100. The networks may use wired and/or wireless communication protocols. The private network 150 may be associated with, for example, an enterprise organization. The private network 150 may interconnect the dynamic robotics automation system parameter platform 105, the computing device(s) 110, the storage device(s) 120, and/or one or more other devices/servers which may be associated with the enterprise organization. The private network 150 may be linked to one or more other private network(s) 160 and/or a public network 170. The public network 170 may comprise the Internet and/or a cloud network. The private network 150 and the private network(s) 160 may correspond to, for example, a local area network (LAN), a wide area network (WAN), a peer-to-peer network, or the like.

A user in a context of the computing environment 100 may be, for example, an associated user (e.g., an employee, an affiliate, or the like) of the enterprise organization. An external user (e.g., a client) may utilize services being provided by the enterprise organization, and access one or more resources located within the private network 150 (e.g., via the public network 170). One or more users may operate one or more devices in the computing environment 100 to send messages to and/or receive messages from one or more other devices connected to or communicatively coupled with the computing environment 100. The enterprise organization may correspond to any government or private institution, an educational institution, a financial institution, a health services provider, a retailer, or the like.

As illustrated in greater detail below, the dynamic robotics automation system parameter platform 105 may comprise one or more computing devices configured to perform one or more of the functions described herein. The dynamic robotics automation system parameter platform 105 may comprise, for example, one or more computers (e.g., laptop computers, desktop computers, computing servers, server blades, or the like).

The computing device(s) 110 may comprise one or more of an enterprise application host platform, an enterprise user computing device, an administrator computing device, and/or other computing devices, platforms, and servers associated with the private network 150. The enterprise application host platform(s) may comprise one or more computing devices and/or other computer components (e.g., processors, memories, communication interfaces). The enterprise application host platform may be configured to host, execute, and/or otherwise provide one or more enterprise applications. The enterprise application host platform(s) may be configured, for example, to host, execute, and/or otherwise provide one or more transaction processing programs, user servicing programs, and/or other programs associated with an enterprise organization. The enterprise application host platform(s) may be configured to provide various enterprise and/or back-office computing functions for an enterprise organization. The enterprise application host platform(s) may comprise various servers and/or databases that store and/or otherwise maintain account information, such as financial/membership account information including account balances, transaction history, account owner information, and/or other information corresponding to one or more users (e.g., external users). The enterprise application host platform(s) may process and/or otherwise execute transactions on specific accounts based on commands and/or other information received from other computer systems comprising the computing environment 100. The enterprise application host platform(s) may receive data from the dynamic robotics automation system parameter platform 105, manipulate and/or otherwise process such data, and/or return processed data and/or other data to the dynamic robotics automation system parameter platform 105 and/or to other computer systems in the computing environment 100.

The enterprise user computing device may comprise a personal computing device (e.g., desktop computer, laptop computer) or mobile computing device (e.g., smartphone, tablet). The enterprise user computing device may be linked to and/or operated by a specific enterprise user (e.g., an employee or other affiliate of an enterprise organization).

The administrator computing device may comprise a personal computing device (e.g., desktop computer, laptop computer) or mobile computing device (e.g., smartphone, tablet). The administrator computing device may be linked to and/or operated by an administrative user (e.g., a network administrator of an enterprise organization). The administrator computing device may receive data from the dynamic robotics automation system parameter platform 105, manipulate and/or otherwise process such data, and/or return processed data and/or other data to the dynamic robotics automation system parameter platform 105 and/or to other computer systems in the computing environment 100. The administrator computing device may be configured to control operation of the dynamic robotics automation system parameter platform 105.

The application(s) 130 may comprise transaction processing programs, user servicing programs, and/or other programs associated with an enterprise organization. The application(s) 130 may correspond to applications that provide various enterprise and/or back-office computing functions for an enterprise organization. The application(s) 130 may correspond to applications that facilitate storage, modification, and/or maintenance of account information, such as financial/membership account information including account balances, transaction history, account owner information, and/or other information corresponding to one or more users (e.g., external users). The application(s) 130 may process and/or otherwise execute transactions on specific accounts based on commands and/or other information received from other computer systems comprising the computing environment 100. The application(s) 130 may operate in a distributed manner across multiple computing devices (e.g., the computing device(s) 110) and/or servers, operate on a single computing device and/or server. The application(s) 130 may be used for execution of various operations corresponding to the one or more computing devices (e.g., the computing device(s) 110) and/or servers.

The storage device(s) 120 may comprise various memory devices such as hard disk drives, solid state drives, magnetic tape drives, or other electronically readable memory, and/or the like. The storage device(s) 120 may be used to store data corresponding to operation of one or more applications within the private network 150 (e.g., the application(s) 130), and/or computing devices (e.g., the computing device(s) 110). The storage device(s) 120 may receive data from the dynamic robotics automation system parameter platform 105, store the data, and/or transmit the data to the dynamic robotics automation system parameter platform 105 and/or to other computing systems in the computing environment 100.

The private network(s) 160 may have an architecture similar to an architecture of the private network 150. The private network(s) 160 may correspond to, for example, another enterprise organization that communicates data with the private network 150. The private network 150 may also be linked to the public network 170. The public network 170 may comprise the external computing device(s) 180. The external computer device(s) 180 may include a personal computing device (e.g., desktop computer, laptop computer) and/or a mobile computing device (e.g., smartphone, tablet). The external computing device(s) 180 may be linked to and/or operated by a user (e.g., a client, an affiliate, or an employee) of an enterprise organization associated with the private network 150. The user may interact with one or more enterprise resources while using the external computing device(s) 180 located outside of an enterprise firewall.

The dynamic robotics automation system parameter platform 105, the computing device(s) 110, the external computing device(s) 180, and/or one or more other systems/devices in the computing environment 100 may comprise any type of computing device capable of receiving input via a user interface, and may communicate the received input to one or more other computing devices. The dynamic robotics automation system parameter platform 105, the computing device(s) 110, the external computing device(s) 180, and/or the other systems/devices in the computing environment 100 may, in some instances, comprise server computers, desktop computers, laptop computers, tablet computers, smart phones, wearable devices, or the like that in turn comprise one or more processors, memories, communication interfaces, storage devices, and/or other components. Any and/or all of the dynamic robotics automation system parameter platform 105, the computing device(s) 110, the storage device(s) 120, and/or other systems/devices in the computing environment 100 may be, in some instances, special-purpose computing devices configured to perform specific functions.

Referring to FIG. 1B, the dynamic robotics automation system parameter platform 105 may comprise one or more of host processor(s) 106, memory 107, medium access control (MAC) processor(s) 108, physical layer (PHY) processor(s) 109, transmit/receive (Tx/Rx) module(s) 109-1, or the like. One or more data buses may interconnect host processor(s) 106, memory 107, MAC processor(s) 108, PHY processor(s) 109, and/or Tx/Rx module(s) 109-1. The dynamic robotics automation system parameter platform 105 may be implemented using one or more integrated circuits (ICs), software, or a combination thereof, configured to operate as discussed below. The host processor(s) 106, the MAC processor(s) 108, and the PHY processor(s) 109 may be implemented, at least partially, on a single IC or multiple ICs. Memory 107 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 108 and/or the PHY processor(s) 109 of the dynamic robotics automation system parameter platform 105 may be configured to generate data units, and process received data units, that conform to any suitable wired and/or wireless communication protocol. For example, the MAC processor(s) 108 may be configured to implement MAC layer functions, and the PHY processor(s) 109 may be configured to implement PHY layer functions corresponding to the communication protocol. The MAC processor(s) 108 may, for example, generate MAC data units (e.g., MAC protocol data units (MPDUs)), and forward the MAC data units to the PHY processor(s) 109. The PHY processor(s) 109 may, for example, generate PHY data units (e.g., PHY protocol data units (PPDUs)) based on the MAC layer data units. The generated PHY data units may be transmitted via the Tx/Rx module(s) 109-1 over the private network 150, the private network(s) 160, and/or the public network 170. Similarly, the PHY processor(s) 109 may receive PHY data units from the Tx/Rx module(s) 109-1, extract MAC layer data units encapsulated within the PHY data units, and forward the extracted MAC data units to the MAC processor(s). The MAC processor(s) 108 may then process the MAC data units as forwarded by the PHY processor(s) 109.

One or more processors (e.g., the host processor(s) 106, the MAC processor(s) 108, the PHY processor(s) 109, and/or the like) of the dynamic robotics automation system parameter platform 105 may be configured to execute machine readable instructions stored in memory 107. Memory 107 may comprise (i) one or more program modules/engines having instructions that when executed by the one or more processors cause the dynamic robotics automation system parameter platform 105 to perform one or more functions described herein, and/or (ii) one or more databases that may store and/or otherwise maintain information which may be used by the one or more program modules/engines and/or the one or more processors. The one or more program modules/engines and/or databases may be stored by and/or maintained in different memory units of the dynamic robotics automation system parameter platform 105 and/or by different computing devices that may form and/or otherwise make up the dynamic robotics automation system parameter platform 105. For example, memory 107 may have, store, and/or comprise a configuration aggregator engine 107-1, a configuration orchestrator engine 107-2, and/or a configuration database 107-3. The configuration aggregator engine 107-1 and the configuration orchestrator engine 107-2 may comprise instructions that direct and/or cause the dynamic robotics automation system parameter platform 105 to perform one or more operations, as discussed in greater detail below. The configuration database 107-3 may comprise, for example, a relational database (e.g., Relational Database Management System (RDBMS), Structured Query Language (SQL) database, and the like) The configuration database 107-3 may store policies and configuration information pertaining to one or more applications 130 being assessed and configured by the dynamic robotics automation system parameter platform 105 for migrating from a first computing system to a second computing system. The configuration database 107-3 may also store user information and/or administrator information corresponding to users and/or administrators, respectively, operating within the computing environment 100. The configuration database 107-3 may also store other information to be used for migration of one or more applications 130 to the second computing system. The configuration database 107-3 may be utilized by the host processor(s) 106 to store and analyze performance data of the components and software within the computing environment 100 in relation with configuration parameter settings as discussed in greater detail below. The configuration database 107-3 may be updated based on training messages and other messages, as discussed in greater detail below.

While FIG. 1A illustrates the dynamic robotics automation system parameter platform 105 as being separate from other elements connected in the private network 150, in one or more other arrangements, the dynamic robotics automation system parameter platform 105 may be included in one or more of the computing device(s) 110, and/or other device/servers associated with the private network 150. Elements in the dynamic robotics automation system parameter platform 105 (e.g., host processor(s) 106, memory(s) 107, MAC processor(s) 108, PHY processor(s) 109, and Tx/Rx module(s) 109-1, one or more program modules and/or stored in memory(s) 107) may share hardware and/or software elements with and corresponding to, for example, one or more of the computing device(s) 110, and/or other device/servers associated with the private network 150.

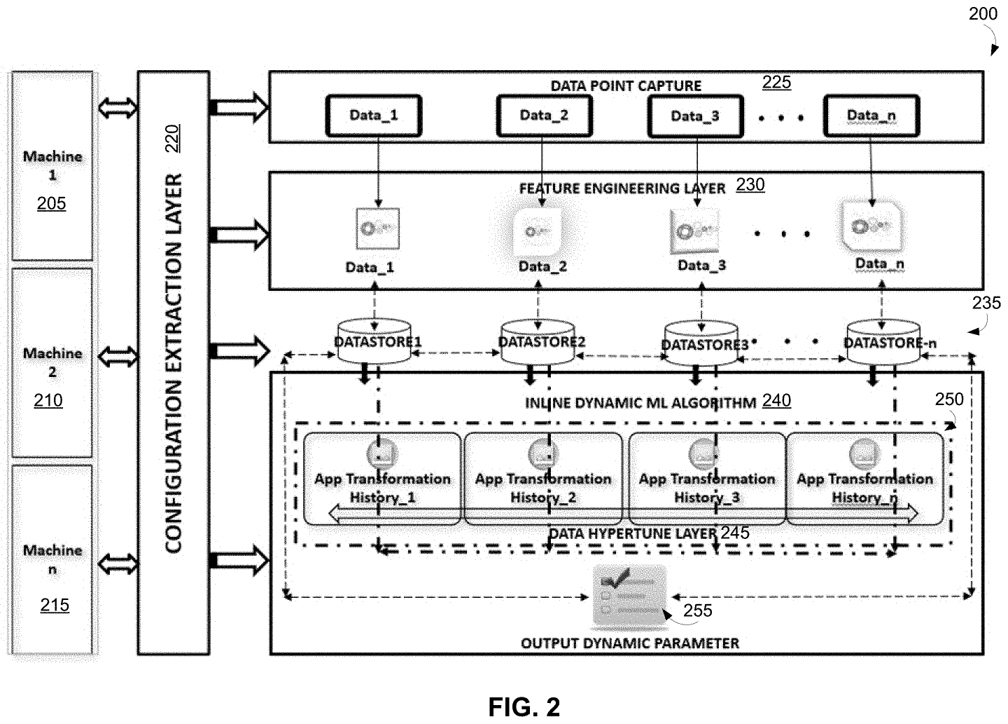

FIG. 2 depicts a system 200 for dynamic configuration parameter settings for robotics automation, in accordance with one or more example arrangements. The system may include the computing environment 100 merely as an example. In other arrangements, the system may include a computing environment different from the computing environment 100. The system may include, for example, the dynamic robotics automation system parameter platform 105.

Two or more processes may execute on a computing system (e.g., machine 1 205, machine 2 210, . . . , machine n 215) in sequence. A time delay between execution of the two or more processes may vary according to environmental factors on the computing system, configuration of the computing system, various factors associated with software corresponding to the two or more processes, and/or the like. The variable time delay may be different based on the processes executing on a different computing system, for example, a different computing system to which the processes are migrated and/or a production computing system vs. a development computing system on which the application(s) associated with the processes were developed. Delays and/or failures may occur when executing the processes on a different computing system than a computing system for which the configuration setting values of the processes were established. Efficient execution of processes in a production computing environment may require a different set of configuration parameter values than those determined in a development computing environment, for example. A quantity of time that is consumed by navigating from one page to another, for example, may be different in a production computing environment than in a development computing environment. A robotics automation process configured to wait a certain quantity of time for navigating from one page to another based on performance measurements in the development computing environment may fail in a production computing environment due to different performance characteristics leading to a different quantity of time consumed by navigating from one page to another, for example. In addition, different processes within a same computing environment may also be configured according to different rules and have different performance characteristics, for example, due to different quantities, types, and paths of data handled by the different processes.

Methods described herein may determine new or changed environmental factors, application configuration parameter values, computing system configuration parameter values, and/or network configuration parameter values that facilitate the processes to execute with reduced or no errors or failures and with increased efficiency than using the same or previous predetermined parameter values and/or environmental factors. The configuration parameter values may be computed according to an artificial intelligence (AI) algorithm, machine learning (ML) algorithm, linear regression algorithm, and/or data-mining a database comprising data pertaining to the performance, parameters, and/or configurations of the application(s) and/or host computing system at various points in time.

Configuration and/or performance data may be determined and/or extracted from data associated with one or more computing systems, e.g., machines 1 205—machine n 215, by a configuration extraction layer 220. The configuration extraction layer 220 may include a software process or utility application that executes on a computing system. The data associated with the one or more computing systems may be captured by a data point capture module 225, for example, as data_1 data_2, data_3, . . . data_n. The captured data may be input into a feature engineering layer 230 for processing. In some examples, feature engineering may include processes for improving performance of machine learning algorithms by processing raw data. In some examples, features, such as individual, measurable properties of a phenomenon being observed, may be engineered by decomposing or splitting features from external data sources, and/or aggregating features to create new features. The feature engineering layer 230 may store the input data and/or processed data in one or more datastores 235, e.g., datastore1, datastore2, datastore3, . . . datastore_n. The data may then be made available to and be utilized by an inline dynamic machine learning algorithm 240 for dynamically setting configuration parameter values. The software process or utility application associated with the configuration extraction layer 220 may continuously run as a background process, for example, on the dynamic robotics automation system parameter platform 105 and/or on any of the machines 1-n 205-215. The inline dynamic ML algorithm 240 may include a data hypertune layer 245 that performs machine learning and dynamically sets configuration parameters according to a stored application transformation history 250 associated with the data operated upon by the inline dynamic ML algorithm 240. The dynamically set configuration parameter values 255 may be output by the inline dynamic ML algorithm 240 to a robotics process automation (RPA) system for use in robotics automation.

The RPA system may launch one or more executable processes (e.g., “bots”) configured to interact with one or more other processes (e.g., “apps”) on one or more of the machines 1-n 205-215 to simulate the actions of a user or another process interacting with the one or more other processes. The bots may be configured to test the robustness and capabilities of the one or more apps under various operating conditions, e.g., user load and/or network data load on the associated machines and/or networks. The bots may be configured according to the dynamically set configuration parameter values 255 to improve the applicability and usefulness of the data generated by the RPA system. During robotics process operation, an execution of a robotics process may output data indicating either a success or a failure and associated data corresponding to the execution of the robotics process. The robotics process operation data may be stored in an associated database 235 for later use by the inline dynamic ML algorithm as part of the corresponding application transformation history 250.

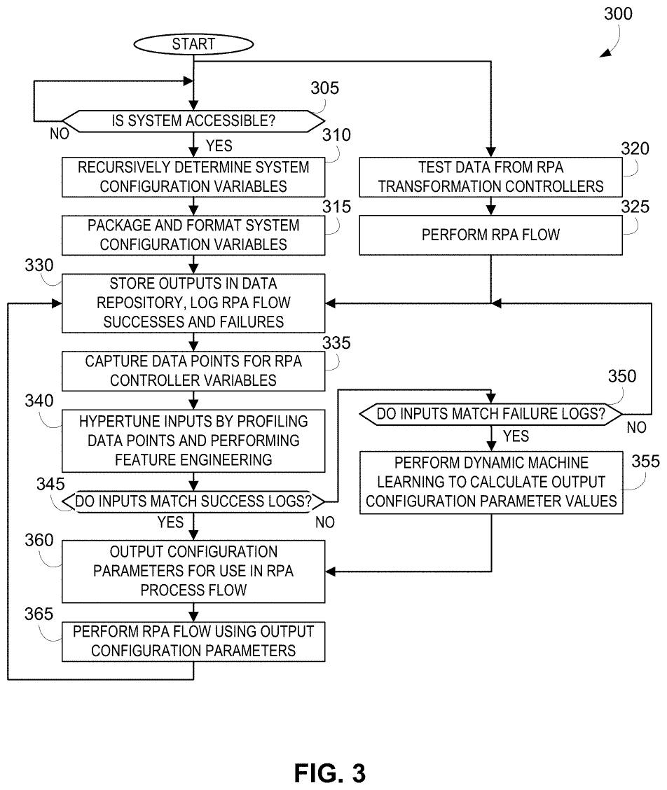

FIG. 3 depicts a process flow 300 for performing dynamic system configuration parameter settings for robotics automation, in accordance with one or more example arrangements. The process flow 300 is described with reference to the computing environment 100 merely as an example. In other arrangements, the illustrative process flow may occur in a computing environment different from the computing environment 100. The illustrative process flow may be executed, for example, by the dynamic robotics automation system parameter platform 105.

At a high level, the process flow 300 may capture system parameters associated with one or more processes executing on one or more computing systems or machines. The process flow 300 may also capture details of RPA parameters. The details may then be analyzed and optimized to determine optimized parameter values and output the parameter values.

If one or more computing systems to be analyzed for determining system configuration parameters are determined to be available (operation 305), an executable process or utility application may determine system configuration variables associated with the one or more computing systems and/or one or more applications that execute on the one or more computing systems (operation 310). The executable process or utility application may recursively determine the system configuration variables. As the executable process or utility application continues to execute, changes in the computing system environment, changes in network data traffic and/or network bandwidth, changes in configuration parameter values, and/or changes in performance may be monitored and logged. The changes may be propagated to other process operations as the executable process or utility application continues to execute. The determined system configuration variables may be packaged and formatted for storage and/or analysis (operation 315). The monitored data and/or configuration variables may be stored in a data repository or database (operation 330).

In parallel with the above-discussed operations 305-315, monitored and/or logged data from RPA transformation controllers may be tested and analyzed (operation 320), and RPA process flows may be performed (operation 325). RPA process flow successes and failures, and/or data associated with the RPA flow execution, may be logged in the data repository or database (operation 330).

Data points may be captured for RPA controller variables (operation 335). Inputs may be hypertuned by profiling data points and performing feature engineering based on the profiled data points (operation 340). In some arrangements, the feature engineering may include preparing or generating an appropriate input dataset (e.g., compatible with the machine learning algorithm requirements, or the like), improving performance of one or more machine learning models by implementing feature engineering checks, such as imputation, log transform, feature split scaling, and, or various other checks, and the like. A determination may be made regarding whether the inputs match data in a database corresponding to logs of successful RPA flows (operation 345). If there is not a match with the success logs, a determination may be made regarding whether the inputs match data in the database corresponding to logs of failed RPA flows (operation 350). If there is also not a match with the failure logs, the data corresponding to the inputs may be stored in the database (operation 330). If there is a match with the failure logs, dynamic machine learning may be performed to calculate output configuration parameter values (operation 355). If there is a match with either the success or failure logs, configuration parameters may be output for use in an RPA process flow (operation 360). The RPA process flow may then be performed using the output configuration parameter values (operation 365). The process flow 300 may continue by looping back to logging RPA flow successes and failures (operation 330).

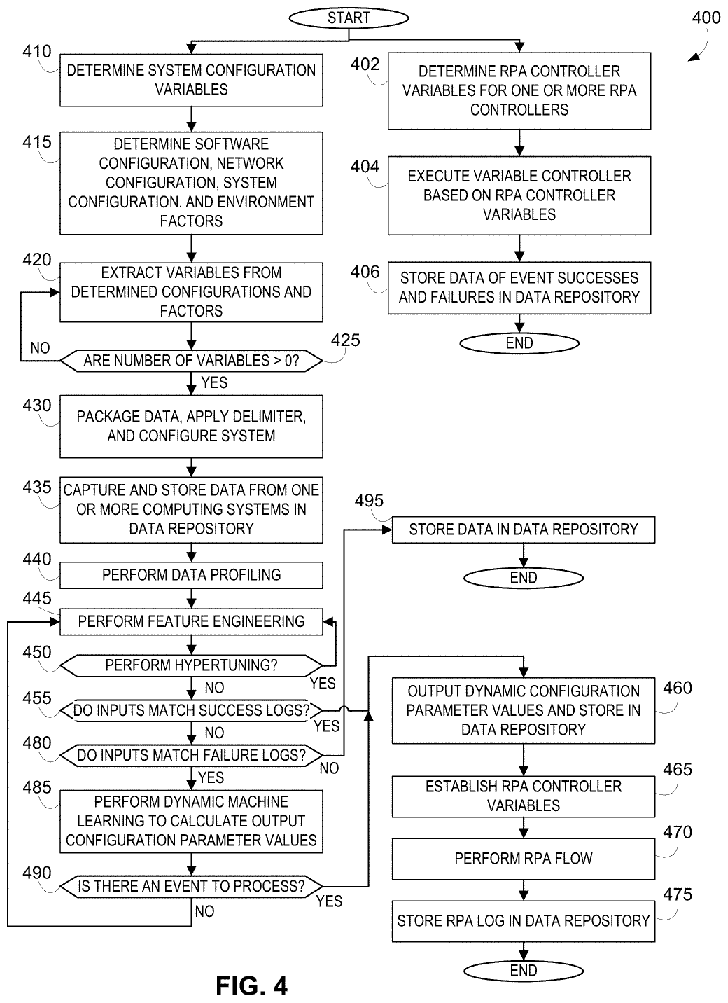

FIG. 4 depicts a process flow 400 for performing dynamic system configuration parameter settings for robotics automation, in accordance with one or more example arrangements. The process flow 400 is described with reference to the computing environment 100 merely as an example. In other arrangements, the illustrative process flow 400 may occur in a computing environment different from the computing environment 100. The illustrative process flow 400 may be executed, for example, by the dynamic robotics automation system parameter platform 105.

Several processes may be executed on a computing system in parallel. In one process, an RPA may be started and an RPA controller's variables may be determined for one or more RPA controllers (operation 402). A variable controller may be executed based on the RPA controller variables (operation 404). Data of event successes and failures may be stored in a data repository (operation 406). In another parallel process, system configuration variables may be determined (operation 410). The variables may be defined and captured directly by RPA processes. A utility, e.g., a Python script, may capture parameter values continually as an ongoing process. The script may determine software configuration, network configuration, system configuration, and/or environment factors (operation 415). Information pertaining to other processes running on the computing system, e.g., an RPA process, may also be captured. The captured information may include how configuration parameter values affect performance of the computing system, network communications infrastructure, and computing servers, for example.

Variables may be extracted from the determined configurations and factors associated with the execution of the utility (operation 420). If the utility is determined to have not captured variables (operation 425), the utility may be executed again. Once all data is received, the data may be packaged and have a delimiter applied thereto (operation 430). The relevant computing system and/or environment may be configured according to the extracted variables. The packaged data may be stored in a data repository or database (operation 435). Data profiling may be performed on the data (operation 440), followed by feature engineering (operation 445). Feature engineering may include, for example, imputation, standardization, feature split, log transform, and the like, and/or may be repeated as long as hypertuning is determined to be needed or beneficial (operation 450). For instance, in some arrangements, hypertuning may including identifying or setting up parameters based on other determined or identified parameters (e.g., selecting a set of parameters for a machine learning algorithm). In some examples, a hyperparameter may include a parameter whose value is used to control the machine learning process, rather than having a value that is learned. If the inputs are determined to match success logs in the database (operation 455), dynamic configuration parameter values may be output and stored in the data repository or database (operation 460). RPA controller variables may be established based on the stored data (operation 465). The associated RPA flow may be performed (operation 470), and the RPA log may be stored in the data repository or database (operation 475).

If the inputs do not match success logs (operation 455), but the inputs do match the failure logs (operation 480), dynamic machine learning may be performed to calculate output configuration parameter values (operation 485). It may be determined whether there is an event to process (operation 490). If there is an event to process, the aforementioned steps of outputting the dynamic configuration parameter values and performing the RPA flow may be performed (operations 460-475). If there is no event to process, the method may return to the operation of performing feature engineering (operation 445). If the inputs do not match either the success logs (operation 455) or the failure logs (operation 480), the data may be stored in the data repository (operation 495).

The process flow 400 may reach back to the feature engineering operation for modification and polishing of parameter values if there is any issue, for example, if parameters are not in the anticipated or designated format or if the parameters give an error during execution of the process.

The methods discussed herein, e.g., the process flow 300 or the process flow 400, may be executed on many different machines. The different machines may represent different computing servers and/or computing environments. In one environment in which the process runs on different machines, more data may be determined and analyzed than in an environment having only one machine. The more data that is determined and analyzed, the more accurate and useful determined parameter values may be. More data may facilitate better training and modeling of computing systems and networks. Parameter values in a production computing environment may be determined beforehand based on a machine learning algorithm. Variables associated with computing systems, networks, software applications, and their respective environments may continually change. Processor and network congestion may vary over time. A quantity of software applications executing on a computing system at once may vary over time.

Different computing systems may have different configuration parameter values. Varying one of the variables, e.g., amount of computing system RAM, may lead to variation in configuration settings and/or performance. Machine learning may be performed by evaluating parameters such as network bandwidth, CPU utilization, computing server data, resources available, a quantity of RPA processes executing, and the like. Machine learning may be performed using data stored on a database while the RPA processes execute. The machine learning may determine operational configuration parameters for RPA bots to use, for example, to accommodate delays between inputting data into an application and waiting for the application to output data responsive to the input data. The machine learning may be used to optimize the RPA bot performance and prevent errors.

In an example, configuration parameters for multiple computing and/or software systems may be captured and analyzed. The captured configuration parameters for the different systems may be compared against associated system performance run data (e.g., success, degradation, fails, and the like). A large volume of data may be collected and stored in a database, and a machine language algorithm may be utilized within a process to determine improved and/or optimized combinations and permutations of configuration parameters to produce improved and/or optimized system performance for all systems being observed. Impact of each system's compute load and performance may be analyzed for their impact on other systems.

Two or more software agents may be utilized to perform the methods described herein. A cognitive bot may provide observation, analysis, and computation of improved and/or optimized configuration parameters. An RPA bot may reconfigure relative parameters in the respective computing systems based on data generated by the cognitive bot.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various examples. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware example, an entirely software example, an entirely firmware example, or an example combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, one or more of the computing system environments discussed above may be combined into a single computing system environment, and the various functions of each computing system environment may be performed by the single computing system environment. In such arrangements, any and/or all of the above-discussed communications between computing system environments may correspond to data being accessed, moved, modified, updated, and/or otherwise used by the single computing system environment. Additionally, or alternatively, one or more of the computing system environments discussed above may be implemented in one or more virtual machines that are provided by one or more physical computing devices. In such arrangements, the various functions of each computing system environment may be performed by the one or more virtual machines, and any and/or all of the above-discussed communications between computing system environments may correspond to data being accessed, moved, modified, updated, and/or otherwise used by the one or more virtual machines.

Aspects of the disclosure have been described in terms of illustrative examples thereof. Numerous other examples, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing system, comprising:
at least one computing processor;
a communication interface communicatively coupled to the at least one computing processor; and
a memory storing computer-readable instructions that, when executed by the at least one computing processor, cause the computing system to:
cause execution, based on a first set of configuration parameter values, of a target application on the computing system;
monitor one or more performance metrics of the computing system;
determine, based on the first set of configuration parameter values and based on the monitored one or more performance metrics, one or more second sets of configuration parameter values; and
cause execution, based on the determined one or more second sets of configuration parameter values, of the target application on the computing system.

2. The computing system of claim 1, wherein the memory further stores computer-readable instructions that, when executed by the at least one computing processor, cause the computing system to:
determine the one or more second sets of configuration parameter values by performing computational optimization, based on the first set of configuration parameter values and based on the monitored one or more performance metrics, of one or more associated configuration parameters.

3. The computing system of claim 1, wherein the memory further stores computer-readable instructions that, when executed by the at least one computing processor, cause the computing system to:
monitor one or more performance metrics of a plurality of layers of an OSI stack associated with execution of the target application on the computing system; and
determine, based on the first set of configuration parameter values and based on the monitored one or more performance metrics of the plurality of layers of the OSI stack, the one or more second sets of configuration parameter values.

4. The computing system of claim 1, wherein the memory further stores computer-readable instructions that, when executed by the at least one computing processor, cause the computing system to:
recursively determine one or more next sets of configuration parameter values based on the one or more second sets of configuration parameter values, one or more subsequent sets of configuration parameter values, and/or one or more monitored performance metrics associated with one or more corresponding sets of configuration parameter values.

5. The computing system of claim 1, wherein the memory further stores computer-readable instructions that, when executed by the at least one computing processor, cause the computing system to:
perform machine learning using at least one of the first set of configuration parameter values or the monitored one or more performance metrics to determine the one or more second sets of configuration parameter values, wherein the one or more performance metrics includes at least one of a success or an error based on a success determination factor or an error determination factor.

6. The computing system of claim 1, wherein the memory further stores computer-readable instructions that, when executed by the at least one computing processor, cause the computing system to:
iterate over a range of values for the first set of configuration parameter values while monitoring the one or more performance metrics; and
determine one or more correlations between one or more of the first set of configuration parameter values or the one or more performance metrics;
wherein determining the one or more second sets of configuration parameter values if further based on the one or more correlations.

7. The computing system of claim 1, wherein the target application comprises robotics automation to simulate performance of the computing system by one or more users.

8. A non-transitory computer-readable medium storing instructions that, when executed, cause performance of:
causing execution, based on a first set of configuration parameter values, of a target application on a computing system;
monitoring one or more performance metrics of the computing system;
determining, based on the first set of configuration parameter values and based on the monitored one or more performance metrics, one or more second sets of configuration parameter values; and
causing execution, based on the determined one or more second sets of configuration parameter values, of the target application on the computing system.

9. The medium of claim 8, further storing instructions that, when executed, cause performance of:
determining the one or more second sets of configuration parameter values by performing computational optimization, based on the first set of configuration parameter values and based on the monitored one or more performance metrics, of one or more associated configuration parameters.

10. The medium of claim 8, further storing instructions that, when executed, cause performance of:
monitoring one or more performance metrics of a plurality of layers of an OSI stack associated with execution of the target application on the computing system; and
determining, based on the first set of configuration parameter values and based on the monitored one or more performance metrics of the plurality of layers of the OSI stack, the one or more second sets of configuration parameter values.

11. The medium of claim 8, further storing instructions that, when executed, cause performance of:
recursively determining one or more next sets of configuration parameter values based on the one or more second sets of configuration parameter values, one or more subsequent sets of configuration parameter values, and/or one or more monitored performance metrics associated with one or more corresponding sets of configuration parameter values.

12. The medium of claim 8, further storing instructions that, when executed, cause performance of:
performing machine learning using at least one of the first set of configuration parameter values or the monitored one or more performance metrics to determine the one or more second sets of configuration parameter values, wherein the one or more performance metrics includes at least one of a success or an error based on a success determination factor or an error determination factor.

13. The medium of claim 8, further storing instructions that, when executed, cause performance of:
iterating over a range of values for the first set of configuration parameter values while monitoring the one or more performance metrics; and
determining one or more correlations between one or more of the first set of configuration parameter values or the one or more performance metrics;
wherein determining the one or more second sets of configuration parameter values if further based on the one or more correlations.

14. The medium of claim 8, wherein the target application comprises robotics automation to simulate performance of the computing system by one or more users.

15. A method comprising:
causing execution, based on a first set of configuration parameter values, of a target application on a computing system;
monitoring one or more performance metrics of the computing system;
determining, based on the first set of configuration parameter values and based on the monitored one or more performance metrics, one or more second sets of configuration parameter values; and
causing execution, based on the determined one or more second sets of configuration parameter values, of the target application on the computing system.

16. The method of claim 15, further comprising:
determining the one or more second sets of configuration parameter values by performing computational optimization, based on the first set of configuration parameter values and based on the monitored one or more performance metrics, of one or more associated configuration parameters.

17. The method of claim 15, further comprising:
monitoring one or more performance metrics of a plurality of layers of an OSI stack associated with execution of the target application on the computing system; and
determining, based on the first set of configuration parameter values and based on the monitored one or more performance metrics of the plurality of layers of the OSI stack, the one or more second sets of configuration parameter values.

18. The method of claim 15, further comprising:
recursively determining one or more next sets of configuration parameter values based on the one or more second sets of configuration parameter values, one or more subsequent sets of configuration parameter values, and/or one or more monitored performance metrics associated with one or more corresponding sets of configuration parameter values.

19. The method of claim 15, further comprising:
performing machine learning using at least one of the first set of configuration parameter values or the monitored one or more performance metrics to determine the one or more second sets of configuration parameter values, wherein the one or more performance metrics includes at least one of a success or an error based on a success determination factor or an error determination factor.

20. The method of claim 15, further comprising:
iterating over a range of values for the first set of configuration parameter values while monitoring the one or more performance metrics; and
determining one or more correlations between one or more of the first set of configuration parameter values or the one or more performance metrics;
wherein determining the one or more second sets of configuration parameter values if further based on the one or more correlations.
